(19) United States
(12) Patent Application Publication
(10) Pub. No.: US 2026/0295889 A1
(43) Pub. Date: Oct. 1, 2026

(54) PORTABLE CUTTING APPARATUS

(71) Applicant: Makita Corporation, Aichi (JP)

(72) Inventor: Syuji AOYAMA, Aichi (JP)

(73) Assignee: Makita Corporation, Aichi (JP)

(21) Appl. No.: 19/632,177

(22) Filed: Mar. 27, 2026

(30) Foreign Application Priority Data
Mar. 27, 2025 (JP) 2025-053120

(51) Int. Cl. B27B 9/02; B27G 19/02; B27G 19/04

(52) U.S. Cl. CPC B27B 9/02; B27G 19/025; B27G 19/04

(57) ABSTRACT

A regulation member is supported by an angular plate in such a manner that the regulation member faces a main body portion in a front-rear direction and rotates about a rotational axis parallel with a tilt axis. The regulation member includes a plurality of second abutment portions respectively corresponding to a plurality of regulation bevel angles. The plurality of second abutment portions are located at positions different from one another in a circumferential direction with respect to the rotational axis and also located at positions different from one another in a radial direction with respect to the rotational axis. The plurality of second abutment portions are configured in such a manner that, when the main body portion is tilted with respect to a base, one second abutment portion determined according to a rotational angle position of the regulation member, among the plurality of second abutment portions, is brought into abutment with a first abutment portion of the main body portion in a direction intersecting with the front-rear direction so that the bevel angle is regulated to the corresponding regulation bevel angle.

### TECHNICAL FIELD

The present disclosure relates a portable cutting apparatus.

### BACKGROUND

Conventionally, there have been known various portable cutting apparatuses (for example, circular saws and cutters) called a plunge type. For example, plunge circular saws (hereinafter also simply referred to as circular saws) include a generally rectangular base having an abutment surface to be placed in abutment with a cutting target material, and a main body portion. The main body portion includes an electric motor and a disk-shaped blade rotationally driven by the electric motor. The blade is contained in a cover in a state of being biased upward by a biasing member.

When using such a circular saw, a user places the circular saw at a cutting start position of the cutting target material so as to bring the abutment surface of the base into abutment with the cutting target material. Next, the user displaces the main body portion downward with the blade rotating. At this time, the lower portion of the blade protrudes downward beyond the base, and starts cutting the cutting target material. Next, the user moves the circular saw forward to a cutting end position. Then, the user stops the rotation of the circular saw and displaces the main body portion upward to return it to an original position.

As one of such circular saws, there is a known type that can tilt the main body portion about a tilt axis extending in a front-rear direction (a direction defined by one side to which the circular saw is advanced when the cutting target material is cut by the blade and the opposite side therefrom) using a member called an angular plate. Such a type of circular saw allows a bevel angle of the main body portion (i.e., the blade) with respect to the base to be fixed at any angle between the minimum bevel angle (for example, 0 degrees, i.e., an angle at which the base and the blade are orthogonal to each other) and the maximum bevel angle (for example, 48 degrees).

Such a circular saw employs a mechanism for allowing the bevel angle of the blade with respect to the base to be easily positioned at a highly frequently used bevel angle (hereinafter referred to as a highly frequent bevel angle) (hereinafter referred to as a bevel angle positioning mechanism).

For example, Japanese Patent Application Laid-Open No. 2007-136794 discloses such a bevel angle positioning mechanism. More specifically, a single pin is attached to an angular plate. The pin extends through the angular plate in the front-rear direction. A knob is attached to one end of the pin. The other end (i.e., a tip) of the pin is moved closer to the main body portion by rotating the knob with a manual operation. On the other hand, the main body portion includes a plurality of steps at positions facing the angular plate. The plurality of steps protrude toward the angular plate by different protrusion amounts. The pin is configured in such a manner that the tip thereof is brought into abutment with one step according to a rotational angle position of the knob among the plurality of steps when the main body portion is tilted with respect to the base. The protrusion amounts of the plurality of steps and the stroke of the pin are set so as to ensure that the tip of the pin and one of the steps are brought into abutment with each other at each of a plurality of highly frequent bevel angles. According to such a configuration, the bevel angle can be easily positioned to a desired highly frequent bevel angle, and can be easily switched among the highly frequent bevel angles.

Such a bevel angle positioning mechanism can be applied to not only the plunge-type circular saw but also various portable cutting apparatuses configured to change a bevel angle of a main body portion with respect to a base.

### SUMMARY

The present specification discloses a portable cutting apparatus. This portable cutting apparatus may include a base and a main body portion. The main body portion may include a rotatable blade and a first abutment portion. The main body portion may be configured to be tilted with respect to the base about a tilt axis extending in a front-rear direction when a front side is defined to be one side to which the portable cutting apparatus is advanced when a cutting target material is cut by the blade and a rear side is defined to be an opposite side from the front side. The portable cutting apparatus may further include an angular plate and a bevel angle switching mechanism. The angular plate may be fixed to the base and support the main body portion tiltably about the tilt axis. The bevel angle switching mechanism may include a regulation member configured to selectively regulate a bevel angle of the blade with respect to the base to one of a plurality of predetermined regulation bevel angles, and be configured to switch the bevel angle among the plurality of regulation bevel angles. Now, the “bevel angle of the blade with respect to the base” refers to an angle from a position where the angle of the blade with respect to the base is a right angle (a state in which the blade is not tilted). The regulation member may be supported by the angular plate in such a manner that the regulation member faces the main body portion in the front-rear direction and rotates about a rotational axis parallel with the tilt axis. The regulation member may include a plurality of second abutment portions respectively corresponding to the plurality of regulation bevel angles. The plurality of second abutment portions may be located at positions different from one another in a circumferential direction with respect to the rotational axis and also located at positions different from one another in a radial direction with respect to the rotational axis. The plurality of second abutment portions may be configured in such a manner that, when the main body portion is tilted with respect to the base, one second abutment portion determined according to a rotational angle position of the regulation member, among the plurality of second abutment portions, is brought into abutment with the first abutment portion in a direction intersecting with the front-rear direction so that the bevel angle is regulated to the corresponding regulation bevel angle.

According to this portable cutting apparatus, the one second abutment portion determined according to the rotational angle position of the regulation member, among the plurality of second abutment portions, is brought into abutment with the first abutment portion of the main body portion in the direction intersecting with the front-rear direction, so that the bevel angle of the blade with respect to the base is regulated to the corresponding regulation bevel angle. This allows the bevel angle of the blade with respect to the base to be easily set to any one of the plurality of regulation bevel angles with a simple apparatus configuration while preventing or reducing an increase in the size of the apparatus.

### BRIEF DESCRIPTION OF THE DRAWINGS

FIG. 1 is a perspective view of a circular saw according to one embodiment as viewed from a front side, and a blade is located at a top dead center.

FIG. 2 is a perspective view of the circular saw as viewed from a rear side, and the blade is located at the top dead center.

FIG. 3 is a front view of the circular saw, and the blade and a main body portion are located at the top dead center and a bevel angle of 0 degrees, respectively.

FIG. 4 is a front view of the circular saw, and the blade and the main body portion are located at a bottom dead center and the bevel angle of 0 degrees, respectively.

FIG. 5 is a perspective view of the main body portion.

FIG. 6 is a partial enlarged perspective view of the circular saw as viewed from the front side with a part of components removed therefrom.

FIG. 7 is a partial enlarged perspective view of the circular saw as viewed from the front side with a part of components removed therefrom.

FIG. 8 is a perspective view of a front-side angular plate, a tilt guide, and a link arm as viewed from the rear side.

FIG. 9 is a perspective view of the front-side angular plate and a bevel angle switching mechanism.

FIG. 10 is a perspective view of the front-side angular plate and the bevel angle switching mechanism.

FIG. 11 is an exploded perspective view of the angular plate and the bevel angle switching mechanism.

FIG. 12 is a partial enlarged view of a cross section taken along a line A-A illustrated in FIG. 3.

FIG. 13 is a front view of the circular saw, and the blade and the main body portion are located at the top dead center and a bevel angle of 22.5 degrees, respectively.

FIG. 14 is a front view of the circular saw, and the blade and the main body portion are located at the top dead center and a bevel angle of 45 degrees, respectively.

FIG. 15 is a front view of the circular saw, and the blade and the main body portion are located at the top dead center and a bevel angle of 48 degrees, respectively.

FIG. 16 illustrates the angular plate and the bevel angle switching mechanism as viewed from the rear side, and the main body portion is located at the bevel angle of 22.5 degrees.

FIG. 17 illustrates the angular plate and the bevel angle switching mechanism as viewed from the rear side, and the main body portion is located at the bevel angle of 45 degrees.

FIG. 18 illustrates the angular plate and the bevel angle switching mechanism as viewed from the rear side, and the main body portion is located at the bevel angle of 48 degrees.

FIG. 19 is a partial front view of a circular saw according to a second embodiment.

### DETAILED DESCRIPTION OF THE EMBODIMENTS

In the following description, representative and non-limiting specific examples of the present invention will be described in detail with reference to the drawings. This detailed description is merely intended to teach a person of skill in the art details for practicing preferred examples of the present invention and is not intended to limit the scope of the present invention. Furthermore, each of additional features and inventions disclosed below can be utilized separately from or together with other features and inventions to provide further improved apparatuses and methods for manufacturing and using the same.

Moreover, combinations of features and steps disclosed in the following detailed description are not necessary to practice the present invention in the broadest sense, and are instead taught merely to particularly describe a representative specific example of the present invention. Furthermore, various features of the above-described and the following representative examples, as well as various features recited in the independent and dependent claims below, do not necessarily have to be combined in herein specifically exemplified manners or enumerated orders to provide additional and useful embodiments of the present invention.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges and indications of groups or aggregations are intended to disclose every possible intermediate individual forming them for the purpose of original written disclosure, as well as for the purpose of restricting the claimed subject matter.

In one or more embodiments, the regulation member may have such a columnar shape that a longitudinal direction thereof extends in the front-rear direction. According to this configuration, the shape of the regulation member can be simplified, and, as a result, an increase in the size of the apparatus can be further reduced.

In one or more embodiments, the regulation member may include a first recessed portion recessed in the radial direction with respect to the rotational axis. The plurality of second abutment portions may include a first rotational angle abutment portion located on an outer peripheral portion of the regulation member and a second rotational angle abutment portion located in the first recessed portion. According to this configuration, the regulation member can be reduced in size.

In one or more embodiments, the first recessed portion may include a bottom portion that is a portion recessed beyond the rotational axis in the radial direction. The second rotational angle abutment portion may be located in the bottom portion. According to this configuration, a large difference can be secured between the regulation bevel angle corresponding to the first rotational angle abutment portion and the regulation bevel angle corresponding to the second rotational angle abutment portion without leading to an increase in the size of the regulation member.

In one or more embodiments, the regulation member may have a C-like shape in cross section taken along a direction orthogonal to the rotational axis. According to this configuration, the function of the regulation member can be realized with a simple shape.

In one or more embodiments, the plurality of second abutment portions may include a third rotational angle abutment portion located in the first recessed portion. According to this configuration, the bevel angle can be switched among at least three regulation bevel angles without leading to an increase in the size of the regulation member.

In one or more embodiments, at least one of the plurality of second abutment portions may be configured in such a manner that a distance thereof from the rotational axis is finely adjustable. According to this configuration, the regulation bevel angle can be accurately set to a desired angle.

In one or more embodiments, the regulation member may include a regulation member main body including the first recessed portion, and an adjustment member partially protruding into the first recessed portion and attached to the regulation member main body in such a manner that a protrusion amount thereof is adjustable. The second rotational angle abutment portion may be located on a portion of the adjustment member that partially protrudes into the first recessed portion and a distance thereof from the rotational axis may be finely adjustable by adjusting the protrusion amount. According to this configuration, the regulation bevel angle can be finely adjusted with a simple configuration and operation.

In one or more embodiments, the second rotational angle abutment portion whose distance from the rotational axis is finely adjustable may correspond to a regulation bevel angle of 45 degrees. According to this configuration, the bevel angle of 45 degrees, which is especially highly frequently used, can be finely adjusted, and therefore user's convenience is improved.

In one or more embodiments, the adjustment member may include an adjustment screw extending in a direction intersecting with the front-rear direction and threadedly engageable with the regulation member main body. According to this configuration, the distance from the rotational axis to the second rotational angle abutment portion can be finely adjusted with a simple operation.

In one or more embodiments, the angular plate may include a second recessed portion, which has a circular arc-shaped inner side surface and is opened toward the main body portion, on one side thereof in the front-rear direction where the main body portion is located. The regulation member may have an outer shape that conforms with the inner side surface of the second recessed portion and be rotatably contained in the second recessed portion. According to this configuration, the regulation member can be smoothly rotated, achieving improved operability of the regulation member for a user.

In one or more embodiments, the bevel angle switching mechanism may further include a pin extending in the front-rear direction through inside the angular plate, and an operation knob located on an opposite side of the angular plate from the main body portion in the front-rear direction. The pin may include a first end located on a closer side to the main body portion and a second end located on a farther side from the main body portion in the front-rear direction. The operation knob may be coupled with the second end. The regulation member may be coupled with the first end and configured to be rotatable integrally with the operation knob via the pin. According to this configuration, the bevel angle switching mechanism can be disposed using a dead space on the opposite side of the angular plate from the main body portion in the front-rear direction, and therefore an increase in the size of the apparatus can be further reduced.

In one or more embodiments, the portable cutting apparatus may further include a tilt guide fixed to the angular plate on a closer side to the main body portion with respect to the angular plate in the front-rear direction and having a through-hole extending in a circular-arc form along a direction in which the main body portion is tilted. The main body portion may include a guide pin extending in the through-hole and slidable on an inner surface defining the through-hole. The tilt axis may be an imaginary axis located opposite of the base from the angular plate. The bevel angle switching mechanism may be located between the tilt guide and the tilt axis as viewed in the front-rear direction. According to this configuration, the bevel angle switching mechanism can be disposed using a dead space between the tilt guide and the tilt axis on the side of the angular plate in the front-rear direction where the main body portion is located, and therefore an increase in the size of the apparatus can be further reduced.

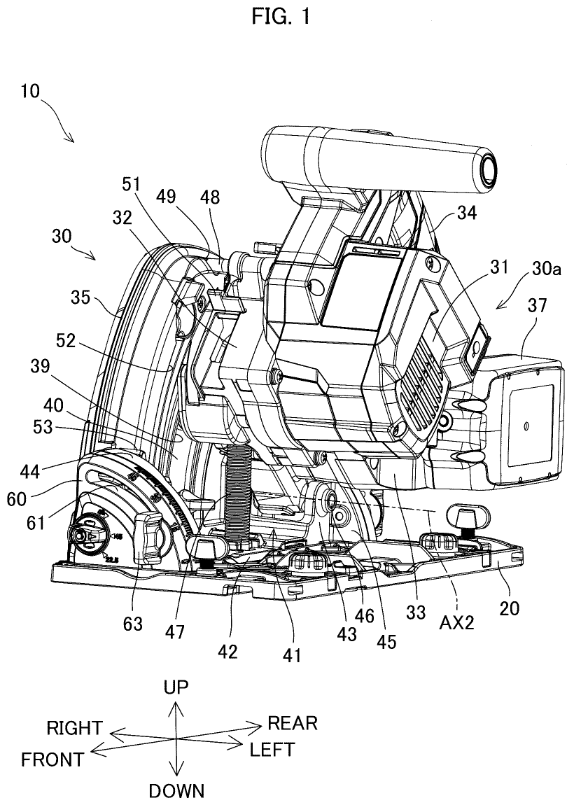

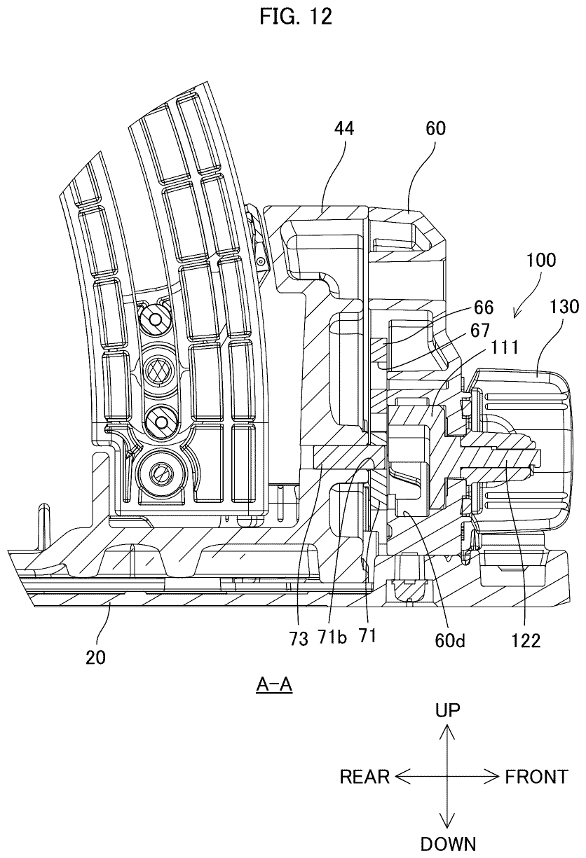

In the following description, a portable circular saw 10 (hereinafter simply referred to as a circular saw) according to one exemplary embodiment will be described in further detail with reference to FIGS. 1 to 18. In the following description, a front side is defined to be a side to which a user advances the circular saw 10 when cutting a cutting target material with the circular saw 10 held in his/her hand (a side to which the cutting proceeds with a blade 40 that will be described below, and this will also be referred to as a cutting direction), and a rear side is defined to be the opposite direction therefrom. Further, an upper side and a lower side are defined to be a side located on an upper side in the vertical direction and the opposite side therefrom in this pose of the circular saw 10 in use, respectively. Further, a left-right direction is defined to be a direction orthogonal to the front-rear direction and the up-down direction. A right side is defined to be a right side in the left-right direction when the front side is viewed from the rear side, and a left side is defined to be the opposite side therefrom.

As illustrated in FIG. 1, the circular saw 10 includes a base 20 and a main body portion 30. The base 20 has a generally rectangular outer shape. The longitudinal direction of the base 20 coincides with the front-rear direction. The circular saw 10 includes a flat lower surface. The circular saw 10 is disposed in such a manner that the lower surface of the base 20 is in abutment with the cutting target material when the circular saw 10 is in use. When the circular saw 10 is used together with a long ruler, the lower surface of the base 20 is disposed on the long ruler placed on the cutting target material.

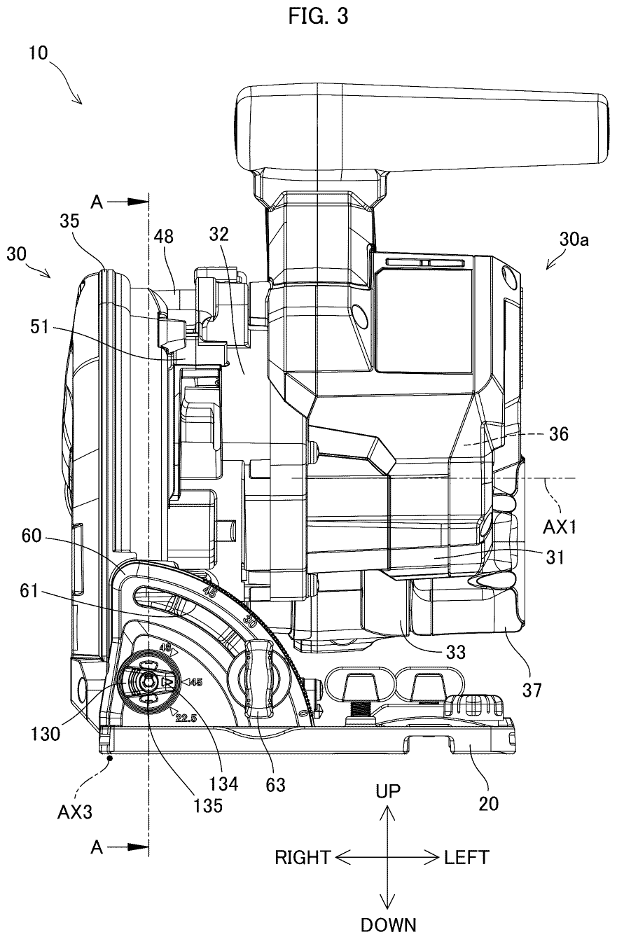

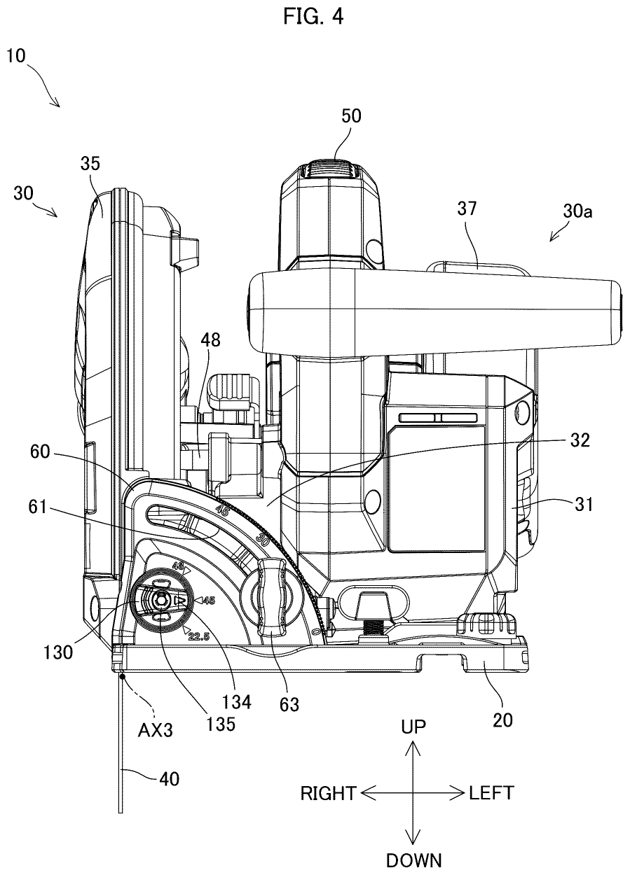

As illustrated in FIG. 1, the main body portion 30 is basically disposed on the upper side with respect to the base 20. As will be described in detail below, the main body portion 30 is a portion tiltable with respect to the base 20 about a tilt axis extending in the front-rear direction. As illustrated in FIGS. 1 to 3, the main body portion 30 includes a motor housing 31, a gear housing 32, a battery mount portion 33, a handle 34, and a cover 35. An electric motor 36 (refer to FIG. 3) is contained in the motor housing 31. A rotational axis AX1 (refer to FIG. 3) of the electric motor 36 extends in the left-right direction. The gear housing 32 is located on the right side of the motor housing 31. A reduction gear and an output shaft extending in the left-right direction are contained in the gear housing 32 (not illustrated). The output shaft is operably coupled with the electric motor 36 via the reduction gear. The output shaft extends rightward out of the gear housing 32, and a blade 40 (refer to FIGS. 1 and 4) is coupled with the right end of the output shaft. The blade 40 is rotated by driving the electric motor 36. In the present embodiment, a circular saw blade called a tipped saw blade is used as the blade 40.

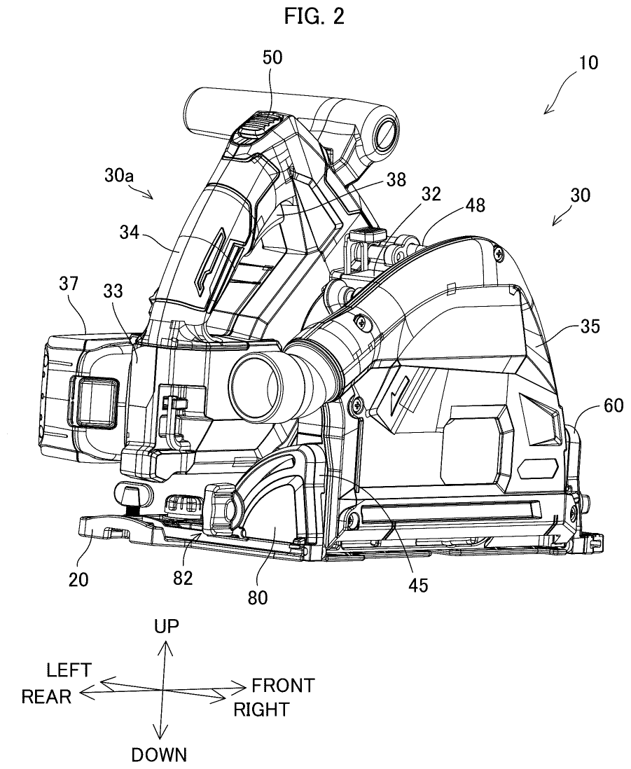

As illustrated in FIG. 2, the battery mount portion 33 is located behind the motor housing 31. The battery mount portion 33 includes a terminal and an engagement portion. The terminal is configured to allow a battery 37 serving as a power source of the circular saw 10 to be detachably attachable thereto, and is electrically connected to the battery 37. The engagement portion is mechanically connected to the battery 37. The handle 34 is disposed to extend across between the gear housing 32 and the battery mount portion 33 so as to allow a user to hold it. A trigger 38 is provided at the front end of the handle 34. The trigger 38 is used to perform an operation of starting up and stopping the electric motor 36.

The cover 35 is located at the right edge portion of the base 20. As illustrated in FIG. 1, the left surface of the cover 35 includes a circular arc-shaped through-hole 39, which extends through the left surface in the left-right direction. The output shaft is inserted through the through-hole 39 to extend to inside the cover 35. The blade 40 coupled with the shaft is contained in the cover 35. The cover 35 has a half-divided configuration, and the left portion and the right portion thereof are coupled to each other using a screw.

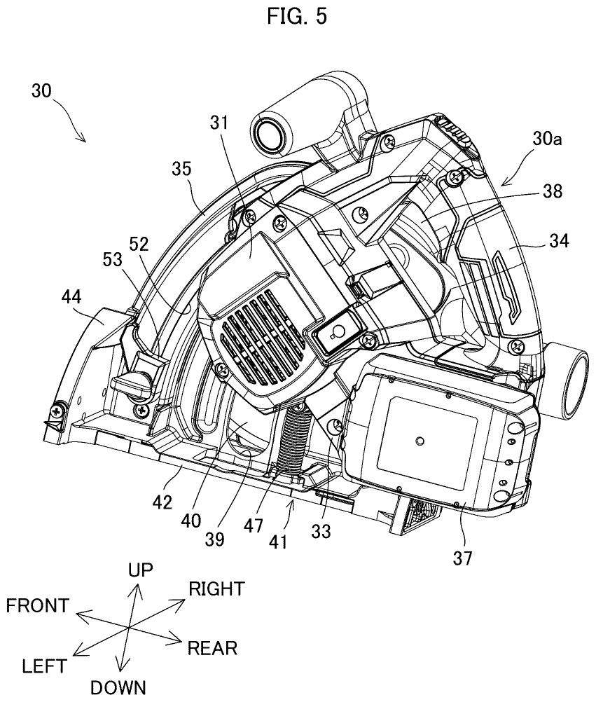

The blade 40 is configured to be swingable with respect to the base 20 and the cover 35. More specifically, as illustrated in FIGS. 1 and 5, the main body portion 30 includes an angular 41. In the present embodiment, the angular 41 is formed integrally with the left-side portion of the cover 35. The angular 41 includes a base portion 42, a shaft support portion 43, a front angular guide 44, and a rear angular guide 45. The base portion 42 is a generally rectangular portion disposed at an approximately right half of the base 20. The right edge portion of the base portion 42 is integrated with the lower edge portion of the left portion of the cover 35. The front angular guide 44 is a portion extending upward from the front edge portion of the base portion 42 in a fan-like form. The rear angular guide 45 is integrated with the rear edge portion of the left portion of the cover 35. The rear angular guide 45 is a portion extending upward from the rear edge portion of the base portion 42 in a fan-like form. The rear angular guide 45 is integrated with the rear edge portion of the left portion of the cover 35. The shaft support portion 43 is located in front of the rear angular guide 45. The shaft support portion 43 is integrated with the rear angular guide 45 and the left portion of the cover 35.

As illustrated in FIG. 1, the shaft support portion 43 has forked portions separated in the left-right direction. The edge portion of the gear housing 32 on the rear side and the lower side is inserted between the forked portions. A support shaft 46 is supported by the shaft support portion 43 in a state of extending through the forked portions of the shaft support portion 43 and the gear housing 32. Due to such a configuration, the gear housing 32 is swingable about the support shaft 46 (i.e., about a swing axis AX2 extending in the left-right direction) together with the motor housing 31, the battery mount portion 33, the handle 34, and the blade 40. In the following description, a portion of the main body portion 30 that is swingable with respect to the base 20 and the cover 35 will also be referred to as a swing portion 30a. The swing portion 30a corresponds to a part of the components of the main body portion 30 excluding the cover 35 and the angular 41.

As illustrated in FIG. 1, a biasing spring 47 is disposed in a compressed state between the base portion 42 of the angular 41 and the gear housing 32. The biasing spring 47 constantly biases the gear housing 32 upward (i.e., in a direction away from the base portion 42). Therefore, in an initial state, the blade 40 is entirely contained in the cover 35 as illustrated in FIGS. 1 and 3. The position of the blade 40 (the swing portion 30a) at this time will also be referred to as a top dead center.

The swing portion 30a is lockable at the top dead center. More specifically, as illustrated in FIG. 1, a lock pin 48 extends from the gear housing 32 toward the cover 35. When the swing portion 30a is located at the top dead center, the tip of the lock pin 48 is fitted in a recessed portion 49 formed on the left surface of the cover 35. The lock pin 48 is constantly biased rightward (i.e., toward the cover 35) by a biasing member (not illustrated). In this state, the lock pin 48 is engaged with the recessed portion 49, and the swing portion 30a is locked at the top dead center. When the user operates a lock release lever 50, the lock pin 48 is retracted leftward against the biasing force of the biasing member. As a result, the engaged state between the lock pin 48 and the recessed portion 49 is released. In this state, the user can press down the swing portion 30a downward.

When the user presses down the swing portion 30a downward, the blade 40 protrudes downward beyond the lower surface of the base 20, becoming ready for cutting the cutting target material. A cutting depth (a protrusion amount of the blade 40 from the lower surface of the base 20) at this time is adjustable. More specifically, as illustrated in FIG. 1, the gear housing 32 includes a protrusion portion 51 below the lock pin 48. The left surface of the cover 35 includes a circular arc-shaped through-hole 52. A stopper 53 is attached in the through-hole 52. The user can press down the swing portion 30a until the protrusion portion 51 abuts against the stopper 53. The stopper 53 can be moved along the through-hole 52 by loosening a thumbscrew thereof. The stopper 53 is fixed to the cover 35 by placing the stopper 53 at a desired position and tightening the thumbscrew. The cutting depth is adjustable by fixing the stopper 53 at a position corresponding to a desired cutting depth. The left surface of the cover 35 includes a scale indicating the cutting depth. An indicator provided to the stopper points to one point of the scale, and this allows the user to easily understand the set cutting depth.

In FIG. 1, the stopper 53 is disposed at a position where the cutting depth is maximized. FIG. 4 illustrates that the swing portion 30a is displaced downward until the protrusion portion 51 abuts against the stopper 53 located at this position. The position of the blade 40 (the swing portion 30a) at this time will also be referred to as a bottom dead center. When the user releases his/her force of pressing down the swing portion 30a with the swing portion 30a located below the top dead center, the swing portion 30a is returned to the top dead center under the biasing force of the biasing spring 47.

As described above, the main body portion 30 including the blade 40 is configured to be tiltable with respect to the base 20. According to this configuration, the cutting target material can be obliquely cut (namely, a bevel cut can be performed). In the following description, a configuration for the bevel cut will be described. As illustrated in FIGS. 1 and 2, the circular saw 10 includes a front angular plate 60 and a rear angular plate 80. The front angular plate 60 and the rear angular plate 80 support the main body portion 30 tiltably about a tilt axis AX3 extending in the front-rear direction. As illustrated in FIGS. 3 and 4, the tilt axis AX3 is an imaginary axis and is located below the base 20 (i.e., the opposite side of the base 20 from the front angular plate 60 in the up-down direction) in the present embodiment. The “imaginary axis” means that this axis is not a central axis of a shaft. For example, the swing axis AX2 illustrated in FIG. 1 coincides with the central axis of the support shaft 46, and therefore is not the “imaginary axis” defined herein.

Each of the front angular plate 60 and the rear angular plate 80 has a circular-arc shape corresponding to an approximately quarter circle as viewed in the front-rear direction, and is fixed to the base 20 using a screw (not illustrated). The front angular plate 60 is located at the front edge portion of the base 20 in the front-rear direction, and is located in a region from the right edge portion to an approximately central position of the base 20 in the left-right direction. The rear angular plate 80 is located at the rear edge portion of the base 20 in the front-rear direction, and is located in a region from the right edge portion to an approximately central position of the base 20 in the left-right direction. The front angular plate 60 and the rear angular plate 80 are functionally similar to each other except for a bevel angle switching mechanism 100 (the details of which will be described below) mounted on the front angular plate 60. Therefore, in the following description, only the front angular plate 60 will be described in detail while the rear angular plate 80 will be just briefed.

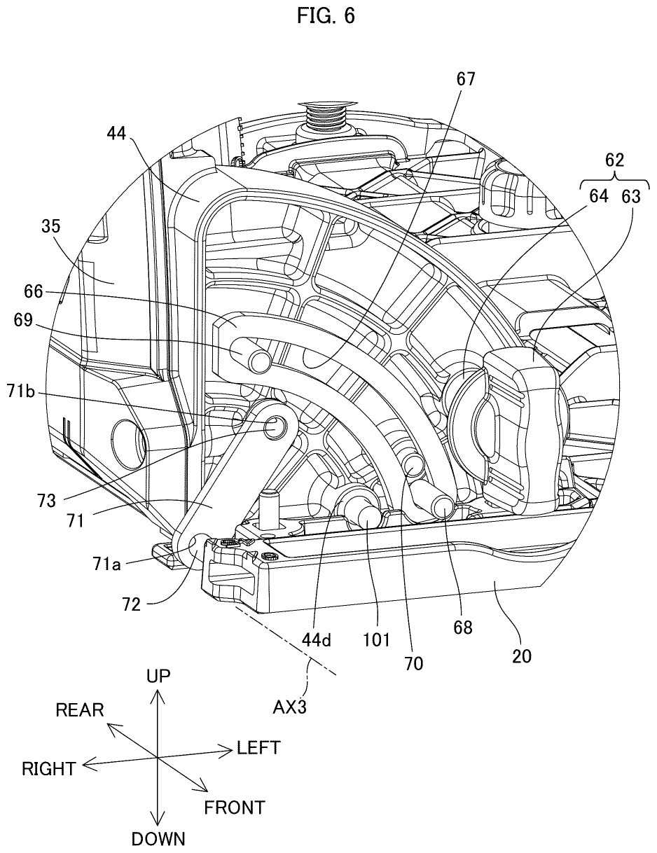

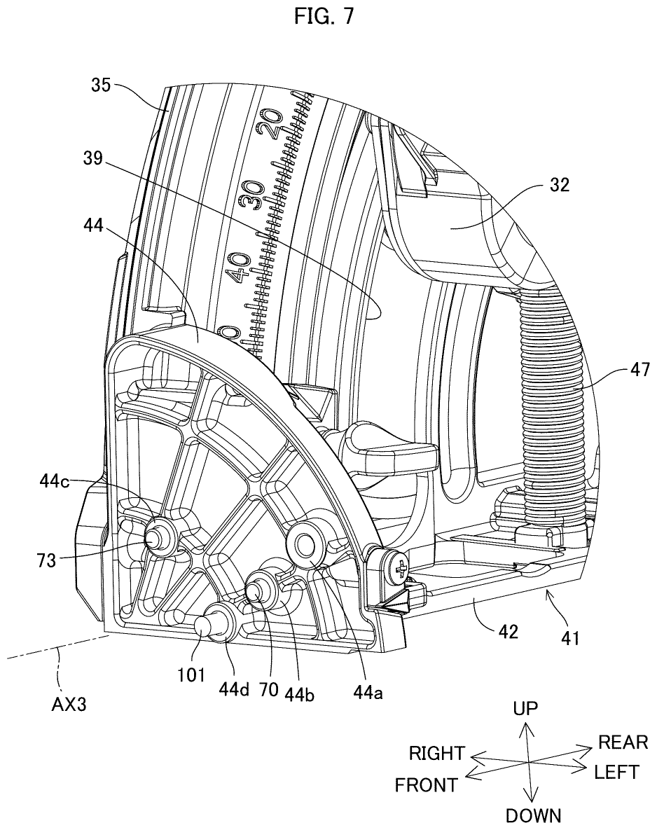

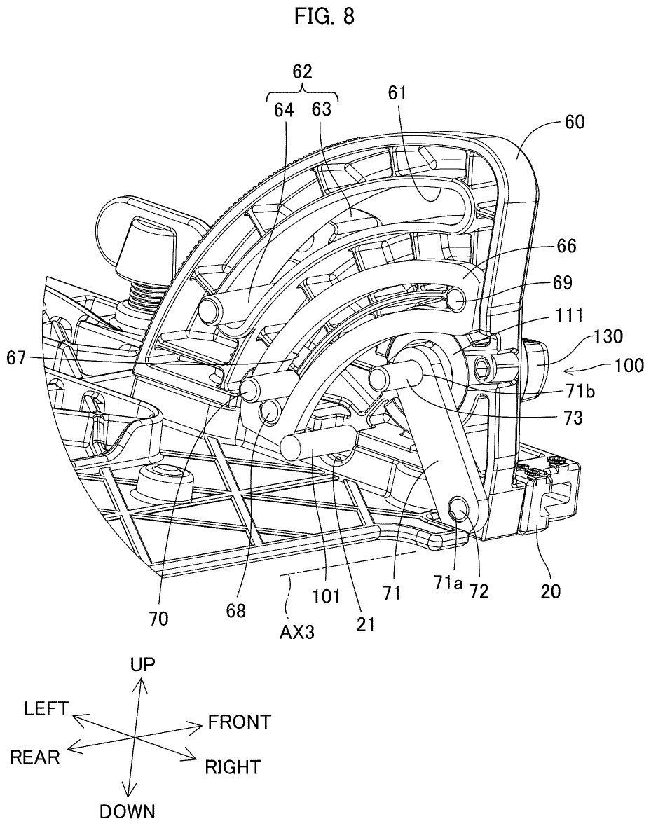

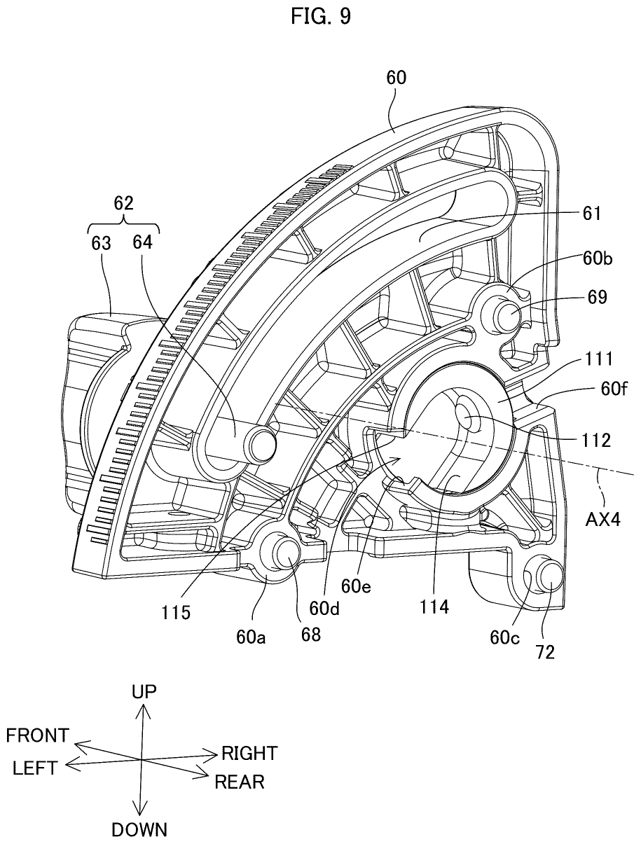

As illustrated in FIG. 1, the front angular plate 60 includes a through-hole 61 extending in the front-rear direction. The through-hole 61 is located near the outer edge portion of the circular arc of the front angular plate 60, and has a circular-arc shape. A thumbscrew 62 is attached to the front angular plate 60 using the through-hole 61. More specifically, as illustrated in FIGS. 8 and 9, the thumbscrew 62 includes an operation knob 63, and a shaft 64 provided with external threads thereon. The front end of the shaft 64 is coupled with the operation knob 63. The thumbscrew 62 is disposed in such a manner that the operation knob 63 is located in front of the front angular plate 60 and the shaft 64 extends through the through-hole 61. As illustrated in FIGS. 6 and 7, the rear end of the shaft 64 is inserted in a threaded boss 44a of the front angular guide 44. The threaded boss 44a includes internal threads engageable with the external threads of the shaft 64. As illustrated in FIG. 2, a thumbscrew 82 is attached to the rear angular plate 80 by a similar configuration.

When the thumbscrews 62 and 82 are loosened, the fixed relationship between the front angular guide 44 and the front angular plate 60, and the fixed relationship between the rear angular guide 45 and the rear angular plate 80 are released. In this state, the main body portion 30 can be tilted with respect to the base 20. Then, when the thumbscrew 62 is tightened at a desired bevel position, the front angular plate 60 is pressed in the front-rear direction by the operation knob 63 and the front angular guide 44. Similarly, when the thumbscrew 82 is tightened, the rear angular plate 80 is pressed in the front-rear direction by an operation knob of the thumbscrew 82 and the rear angular guide 45. As a result, the fixed relationship between the angular 41, and the front angular plate 60 and the rear angular plate 80 is established, and the bevel angle of the main body portion 30 with respect to the base 20 is fixed.

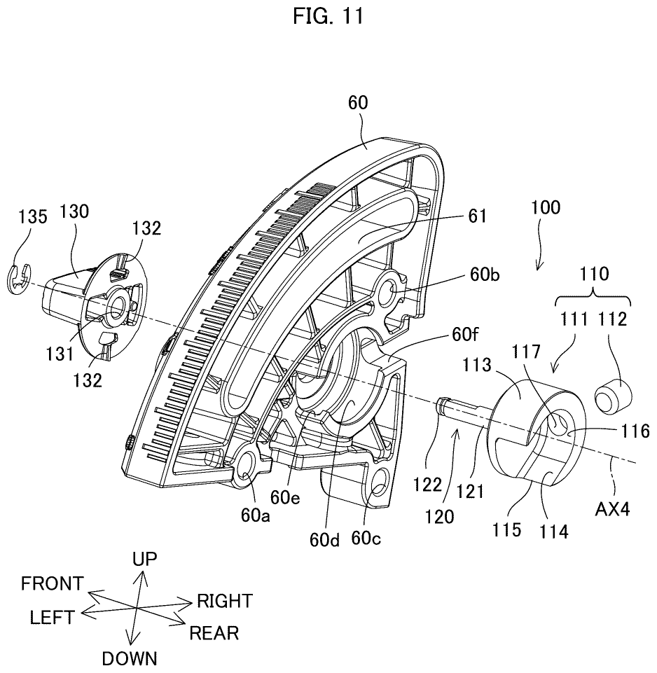

As illustrated in FIGS. 6, 8, and 12, a tilt guide 66 made of steel is disposed behind the front angular plate 60. The tilt guide 66 includes a through-hole 67 extending in a circular-arc form along a direction in which the main body portion 30 is tilted. The through-hole 67 extends through the tilt guide 66 in the front-rear direction. As illustrated in FIGS. 9 and 11, the front angular plate 60 includes bosses 60a and 60b each having a bottomed hole opened rearward. Positioning pins 68 and 69 are press-fitted in the bottomed holes of the bosses 60a and 60b, respectively. As illustrated in FIGS. 6 and 8, the tilt guide 66 is fixed to the front angular plate 60 in such a manner that the positioning pins 68 and 69 extend through the through-hole 67. The tilt guide 66 is located on the inner side of the through-hole 61 in a radial direction with respect to the tilt axis AX3. As illustrated in FIG. 8, when the tilt guide 66 is attached, the positioning pins 68 and 69 are located at both the edge portions of the circular-arc shape of the through-hole 67, respectively, and fitted to the inner surface defining the through-hole 67. According to this configuration, the tilt guide 66 can be correctly positioned relative to the front angular plate 60 with the aid of the positioning pins 68 and 69.

As illustrated in FIG. 7, the front angular guide 44 includes a boss 44b having a bottomed hole opened forward. A guide pin 70 is press-fitted in the bottomed hole of the boss 44b. As illustrated in FIGS. 6 and 8, the guide pin 70 extends in the through-hole 67 of the tilt guide 66. When the main body portion 30 is tilted with respect to the base 20, the guide pin 70 slidably moves on the inner surface defining the through-hole 67. Due to this configuration, the tilt motion of the main body portion 30 is smoothly guided.

As illustrated in FIGS. 6, 8, and 12, a link arm 71 is disposed behind the front angular plate 60 and in front of the front angular guide 44. The link arm 71 is a linearly extending plate. The link arm 71 is located on the inner side of the tilt guide 66 in the radial direction with respect to the tilt axis AX3. The link arm 71 includes through-holes 71a and 71b at both the end portions thereof, respectively. The through-holes 71a and 71b extend through the link arm 71 in the front-rear direction.

As illustrated in FIGS. 9 and 11, the front angular plate 60 includes a through-hole 60c at the edge portion on the lower side and the right side thereof. A support shaft 72 is inserted in the through-hole 60c. As illustrated in FIG. 6, the front end of the support shaft 72 is press-fitted in a hole (not illustrated) of the base 20. As illustrated in FIGS. 6 and 9, the rear end of the support shaft 72 is inserted in the through-hole 71a of the link arm 71 with a slight clearance generated therebetween. Due to that, the link arm 71 is rotatable about the support shaft 72.

As illustrated in FIG. 7, the front angular guide 44 includes a boss 44c having a bottomed hole opened forward. An engagement pin 73 is press-fitted in the bottomed hole of the boss 44c. As illustrated in FIGS. 6, 8, and 12, the front end of the engagement pin 73 is also inserted in the through-hole 71b of the link arm 71 with a slight clearance generated therebetween. Therefore, the link arm 71 is rotatable about the engagement pin 73.

When the main body portion 30 is tilted with respect to the base 20, the link arm 71 is tilted about the support shaft 72 in conjunction with the tilt motion of the main body portion 30. According to the configuration in which the link arm 71 couples the front angular guide 44 and the front angular plate 60 in this manner, rattling can be eliminated or reduced between the front angular guide 44 and the front angular plate 60 even when the bevel angle increases. Therefore, the main body portion 30 can be smoothly tilted with respect to the base 20. Although being not illustrated, the rear angular guide 45 and the rear angular plate 80 are also configured similarly to the above-described configuration of the front angular guide 44 and the front angular plate 60.

In the present embodiment, the minimum value of the bevel angle of the main body portion 30 (the blade 40) with respect to the base 20 (hereinafter also simply referred to as a bevel angle) is 0 degrees. At this time, the blade 40 is orthogonal to the base 20 as illustrated in FIG. 4. The relative position between the base 20 and the main body portion 30 when the bevel angle is 0 degrees is defined due to abutment of the base portion 42 of the angular 41 with the upper surface of the base 20 as illustrated in FIG. 1.

The circular saw 10 includes the bevel angle switching mechanism 100 for allowing the bevel angle to be easily positioned to a plurality of highly frequent tilt angles (they are highly frequently used bevel angles). The bevel angle switching mechanism 100 is configured to regulate the bevel angle of the main body portion 30 with respect to the base 20 to one of a plurality of predetermined regulation bevel angles, and is also configured to switch the bevel angle among the plurality of regulation bevel angles. The plurality of highly frequent bevel angles are set as the plurality of bevel angles (the plurality of regulation bevel angles). In the present embodiment, the plurality of bevel angles are 22.5 degrees, 45 degrees, and 48 degrees. However, the plurality of bevel angles can be set to any two or more angles. In the following description, the bevel angle switching mechanism 100 will be described in detail.

As illustrated in FIGS. 6 and 7, the front angular guide 44 includes a first abutment portion 101. In the present embodiment, the first abutment member 101 is in the form of a stopper pin. More specifically, the front angular guide 44 includes a boss 44d having a bottomed hole opened forward. The first abutment portion 101 is press-fitted in the bottomed hole of the boss 44d, and protrudes from the front angular guide 44 forward (toward the front angular plate 60). As illustrated in FIG. 8, the first abutment portion 101 extends through the recessed portion 21 of the base 20 to a position in the front-rear direction that overlaps the front angular plate 60.

The first abutment portion 101 and the front angular guide 44 are provided as separate members, and this allows optimum materials to be selected for the functions of the first abutment portion 101 and the front angular guide 44. For example, selecting resin and metal as the materials of the front angular guide 44 and the first abutment portion 101, respectively, can contribute to ensuring rigidity necessary for the first abutment portion 101 without leading to an increase in the size of the first abutment portion 101 while reducing the weight of the front angular guide 44. However, the first abutment portion 101 is not limited to being in the form of a stopper pin, and can be deformed to any form. For example, the first abutment portion 101 and the front angular guide 44 may be an integral molded member.

As illustrated in FIG. 11, the bevel angle switching mechanism 100 includes a regulation member 110, a pin 120, and an operation knob 130. In the present embodiment, the regulation member 110 has such a columnar shape that the longitudinal direction (the axial direction) thereof extends in the front-rear direction. The columnar shape refers to a cylindrical shape or a generally cylindrical shape, and the generally cylindrical shape includes, for example, a polygon or a combination of a polygon and a circle as viewed in the axial direction. The regulation member 110 includes a regulation member main body 111 and an adjustment member 112.

The pin 120 extends in the front-rear direction through inside the front angular plate 60 (more specifically, a second recessed portion 60d, which will be described below). The pin 120 includes a first end 121 and a second end 122. The first end 121 is located on a closer side to the main body portion 30 (i.e., the rear side) in the front-rear direction. The second end 122 is located on a farther side from the main body portion 30 (i.e., the front side). The operation knob 130 is disposed on the front side of the front angular plate 60. The operation knob 130 includes a through-hole 131 at the center thereof. The through-hole 131 extends in the front-rear direction. Further, the operation knob 130 includes a pair of protrusion portions 132 at the rear end portion thereof. The protrusion portions 132 protrude rearward. The operation knob 130 is made of resin.

The first end 121 of the pin 120 is coupled with the regulation member 110 by being press-fitted in a hole portion (not illustrated) of the regulation member 110. The pin 120 and the regulation member 110 may be integrally molded by, for example, insert-molding. The second end 122 of the pin 120 extends through the through-hole 131 of the operation knob 130. A stop ring 135 is attached in an annular groove formed at the second end 122 (refer to FIG. 3), so that the second end 122 is coupled with the operation knob 130. As will be described in detail below, the regulation member 110 is supported by the front angular plate 60 such a manner that the regulation member 110 is rotatable about a rotational axis AX4 integrally with the operation knob 130 via the pin 120. The rotational axis AX4 is in parallel with the front-rear direction (i.e., the tilt axis AX3), and coincides with the central axis of the pin 120.

As illustrated in FIG. 11, in the present embodiment, the regulation member main body 111 has a generally cylindrical shape extending in the front-rear direction. The regulation member main body 111 includes a first recessed portion 114 recessed in a radial direction with respect to the rotational axis AX4. In the present embodiment, the first recessed portion 114 is recessed as far as a position beyond the rotational axis AX4. A portion of the first recessed portion 114 that is recessed beyond the rotational axis AX4 will also be referred to as a bottom portion 116. The first recessed portion 114 extends from around the front edge portion to the rear edge portion of the regulation member main body 111 in the front-rear direction. The regulation member main body 111 has a C-like shape in cross section taken along a direction orthogonal to the rotational axis AX4 at a position in the front-rear direction where the first recessed portion 114 is formed. An opening portion 115 opened radially outward is defined by the first recessed portion 114. In the present embodiment, an outer peripheral portion 113 of the regulation member main body 111 has a constant radius. In other words, the distance between the outer peripheral portion 113 and the rotational axis AX4 is kept constant regardless of the circumferential position.

As illustrated in FIG. 11, the regulation member main body 111 includes a threaded hole 117. The threaded hole 117 extends in a direction intersecting with the front-rear direction. In the present embodiment, the threaded hole 117 extends in a direction orthogonal to the front-rear direction. Internal threads are formed on the inner surface defining the threaded hole 117. The threaded hole 117 establishes communication between the first recessed portion 114 (more specifically, the bottom portion 116) and outside the regulation member main body 111. In the present embodiment, the adjustment member 112 is in the form of an adjustment screw (more specifically, a set screw). The adjustment member 112 includes external threads engageable with the internal threads of the threaded hole 117.

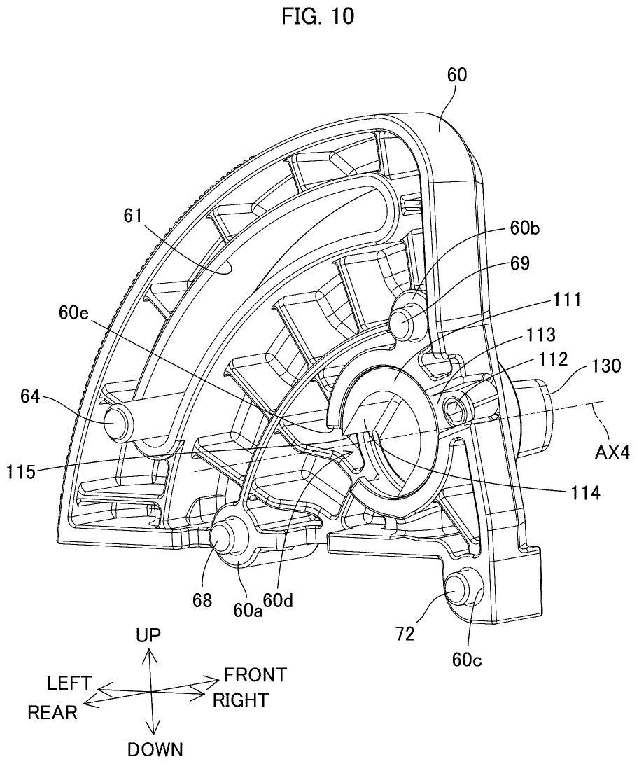

As illustrated in FIGS. 9 to 11, the adjustment member 112 is inserted in the threaded hole 117. As illustrated in FIG. 9, the tip of the adjustment member 112 protrudes radially inward beyond the inner surface of the first recessed portion 114. The tip of the adjustment member 112 is located in the bottom portion 116. The amount of the protrusion of the adjustment member 112 can be finely adjusted by rotating the adjustment member 112. As illustrated in FIG. 10, the second recessed portion 60d has a large diameter so as to prevent the end of the adjustment member 112 from protruding out of the outer peripheral portion 113, and a space of an adequate size is generated between the second recessed portion 60d and the outer peripheral portion 113.

As illustrated in FIG. 11, the front angular plate 60 includes the second recessed portion 60d on the rear side thereof. The second recessed portion 60d has a circular arc-shaped inner side surface. The second recessed portion 60d is opened rearward (i.e., toward the main body portion 30). The second recessed portion 60d includes an opening portion 60e and an opening portion 60f on the left side and the right side, respectively. The opening portion 60f is formed to secure a space for rotating the adjustment member 112. The regulation member 110 is contained into the second recessed portion 60d by being inserted from the rear side. In this state, the regulation member 110 faces the front angular guide 44 in the front-rear direction. The regulation member 110 has an outer shape (i.e., the outer peripheral portion 113) that conforms with the inner surface of the inside of the second recessed portion 60d. Therefore, the regulation member 110 is smoothly rotatable in the front angular plate 60. As a result, the operation knob 63 can be rotated with improved operability.

The bevel angle switching mechanism 100 configured in this manner is configured to switch the bevel angle between the plurality of regulation bevel angles (22.5 degrees, 45 degrees, and 48 degrees) in the following manner. This will be described, first referring to an example when the bevel angle is set to 22.5 degrees. As illustrated in FIG. 3, the plurality of settable regulation bevel angles (22.5 degrees, 45 degrees, and 48 degrees) are displayed on the front surface of the front angular plate 60. Further, an indicator 134 is displayed on the front surface of the operation knob 130. By rotationally operating the operation knob 130 so as to cause the indicator 134 to point to a desired regulation bevel angle, the bevel angle switching mechanism 100 is positioned in such a manner that the rotational angle position of the bevel angle switching mechanism 100 corresponds to this regulation bevel angle.

Although being not illustrated, a plurality of grooves into which the protrusion portions 132 (refer to FIG. 11) of the operation knob 130 can be fitted is defined at positions of the front surface of the front angular plate 60 that face the operation knob 130. When the operation knob 130 is located at a position where it points to one of the plurality of regulation bevel angles, the pair of protrusion portions 132 are fitted in the pair of corresponding grooves, respectively. When the user rotationally operates the operation knob 130 in this state, the protrusion portions 132 are elastically deformed and disengaged from the grooves. According to such a configuration, the user can easily position the operation knob 130 to a correct rotational position.

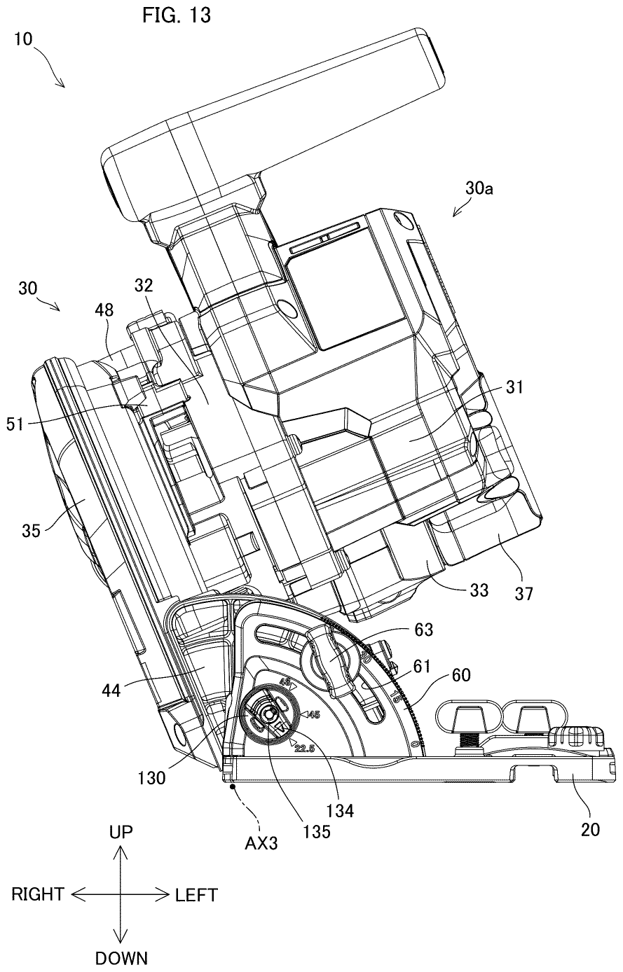

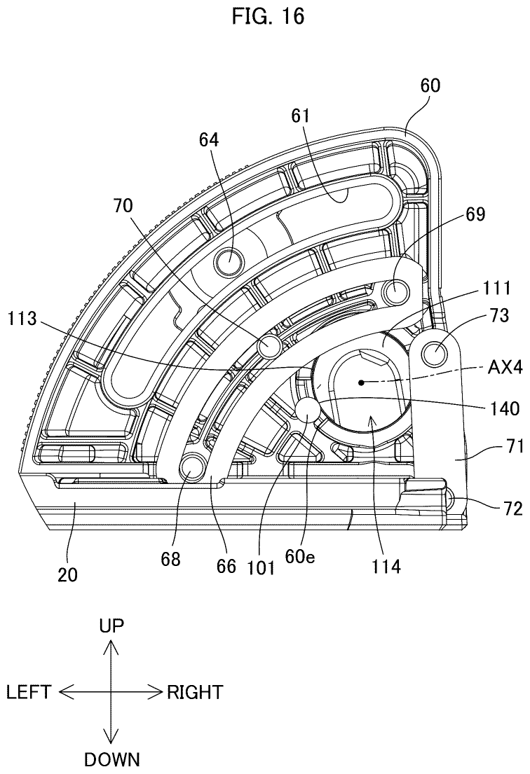

When setting the bevel angle to 22.5 degrees, the user rotationally operates the operation knob 130 to a rotational angle position where the indicator 134 points to 22.5 degrees, as illustrated in FIG. 13. At this time, the regulation member main body 111 is located at a rotational angle position where the outer peripheral portion 113 thereof closes the opening portion 60e of the front angular plate 60, as illustrated in FIG. 16. Next, when the user loosens the operation knob 63 and tilts the main body portion 30 by 22.5 degrees from the rotational angle position corresponding to the bevel angle of 0 degrees, the first abutment portion 101 fixed to the main body portion 30 (more specifically, the front angular guide 44) is rotationally displaced via a route starting from the initial position illustrated in FIG. 8 and passing through the opening portion 60e, and is brought into abutment with the outer peripheral portion 113 of the regulation member main body 111 in a direction intersecting with the front-rear direction (a direction orthogonal to the front-rear direction in the present embodiment). Therefore, the first abutment portion 101 cannot be rotationally displaced more than that in a direction for increasing the bevel angle. As a result, the bevel angle is regulated to the 22.5 degrees. A portion of the regulation member main body 111 in abutment with the first abutment portion 101 at this time will be referred to as a second abutment portion 140.

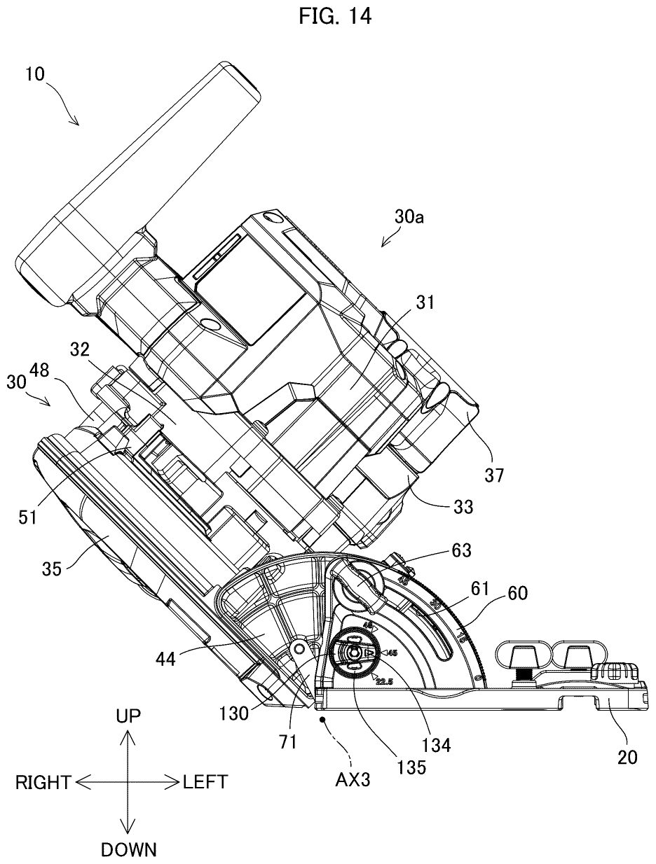

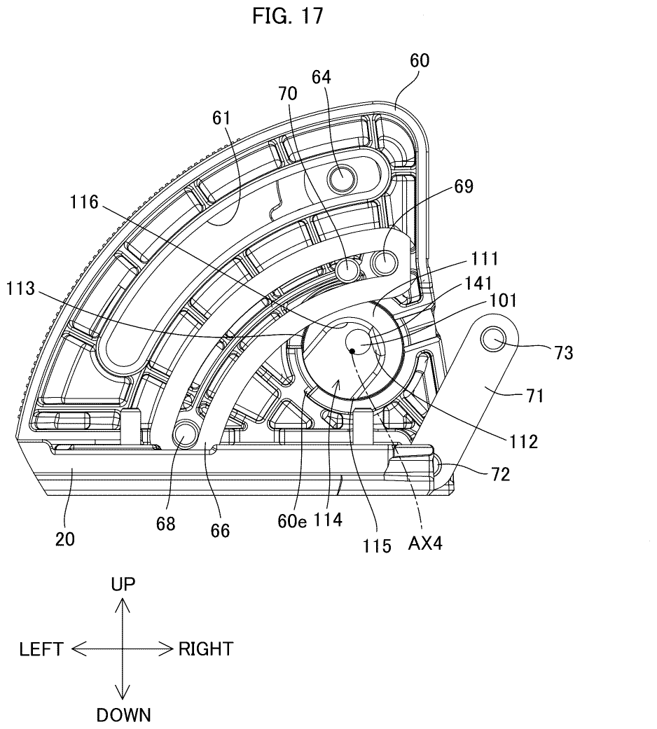

When setting the bevel angle to 45 degrees, the user rotationally operates the operation knob 130 to a rotational angle position where the indicator 134 points to 45 degrees, as illustrated in FIG. 14. At this time, the outer peripheral portion 113 of the regulation member main body 111 is located at a rotational angle position where it does not close the opening portion 60e of the front angular plate 60, as illustrated in FIG. 17. At this time, the inner space in the first recessed portion 114 is in communication with the outside via the opening portion 60e and the opening portion 115 of the regulation member main body 111. Next, when the user loosens the operation knob 63 and tilts the main body portion 30 by 45 degrees from the rotational angle position corresponding to the bevel angle of 0 degrees, the first abutment portion 101 starts from the initial position illustrated in FIG. 8 to pass through the opening portion 60e and the opening portion 115 to enter the first recessed portion 114, and is brought into abutment with the tip of the adjustment member 112 in a direction intersecting with the front-rear direction. Therefore, the first abutment portion 101 cannot be rotationally displaced more than that in a direction for increasing the bevel angle. As a result, the bevel angle is regulated to the 45 degrees. A portion of the regulation member 110 in abutment with the first abutment portion 101 at this time will be referred to as a second abutment portion 141. The second abutment portion 141 is located in the first recessed portion 114.

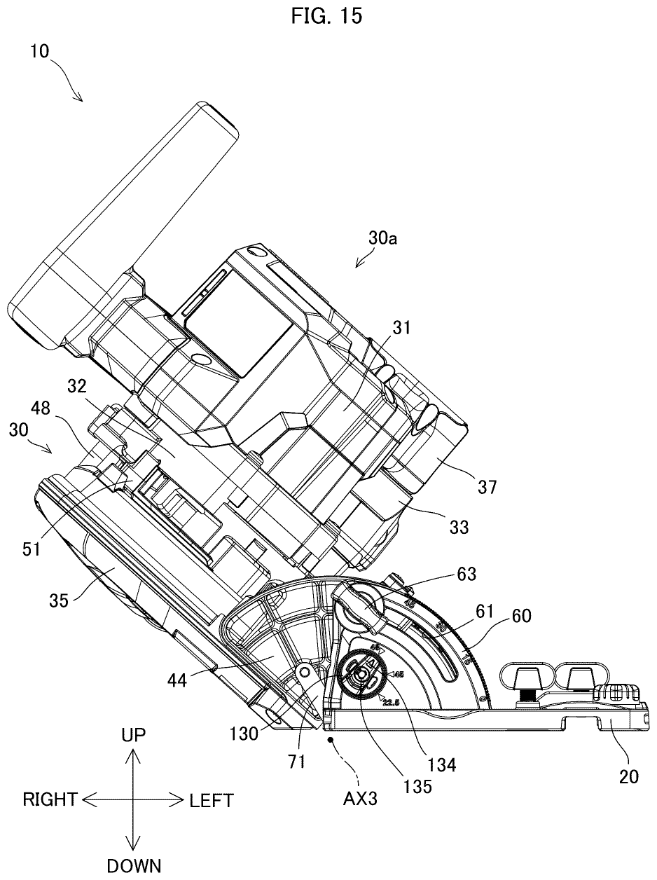

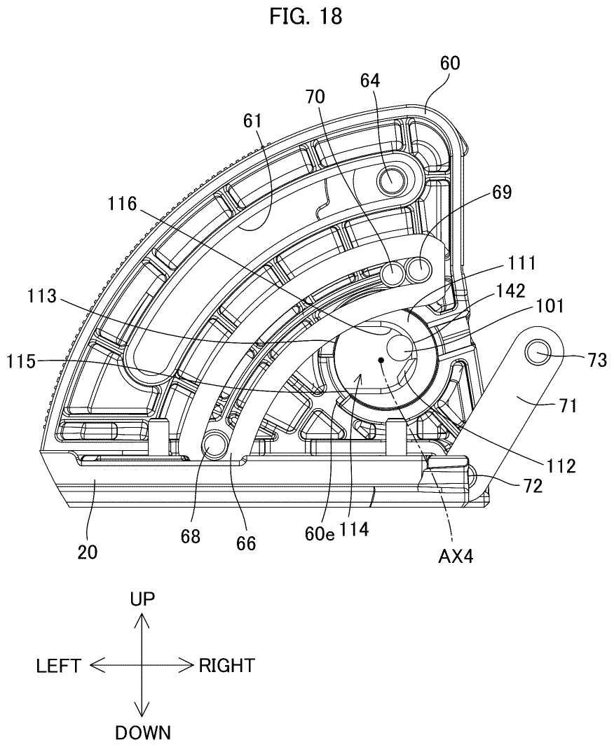

When setting the bevel angle to 48 degrees, the user rotationally operates the operation knob 130 to a rotational angle position where the indicator 134 points to 48 degrees, as illustrated in FIG. 15. At this time, the outer peripheral portion 113 of the regulation member main body 111 is located at a rotational angle position where it does not close the opening portion 60e of the front angular plate 60, as illustrated in FIG. 18. Next, when the user loosens the operation knob 63 and tilts the main body portion 30 by 48 degrees from the rotational angle position corresponding to the bevel angle of 0 degrees, the first abutment portion 101 starts from the initial position illustrated in FIG. 8 to pass through the opening portion 60e and the opening portion 115 to enter the first recessed portion 114, and is brought into abutment with the first recessed portion 114 (more specifically, the bottom portion 116) in a direction intersecting with the front-rear direction. Therefore, the first abutment portion 101 cannot be rotationally displaced more than that in a direction for increasing the bevel angle. As a result, the bevel angle is regulated to the 48 degrees. A portion of the regulation member main body 111 in abutment with the first abutment portion 101 at this time will be referred to as a second abutment portion 142. The second abutment portion 142 is located in the first recessed portion 114.

According to the circular saw 10 including the above-described bevel angle switching mechanism 100, the regulation member 110 includes the second abutment portions 140, 141, and 142 respectively corresponding to the plurality of regulation bevel angles. The second abutment portions 140, 141, and 142 are located at positions different from one another in the circumferential direction with respect to the rotational axis AX4 and also located at positions different from one another in the radial direction with respect to the rotational axis AX4. Then, when the main body portion 30 is tilted with respect to the base 20, one second abutment portion determined according to the rotational angle position of the regulation member 110, between the second abutment portions 140, 141, and 142, is brought into abutment with the first abutment portion 101 in the direction intersecting with the front-rear direction, so that the bevel angle is regulated to the corresponding regulation bevel angle. This allows the bevel angle of the blade 40 with respect to the base 20 to be easily set to any one of the plurality of regulation bevel angles with a simple apparatus configuration while eliminating or reducing an increase in the size of the apparatus.

Further, according to the bevel angle switching mechanism 100, the second abutment portion 140 is located on the outer peripheral portion 113 of the regulation member main body 111, and the second abutment portions 141 and 142 are located in the first recessed portion 114. According to this configuration, the regulation member 110 can be reduced in size compared with a configuration in which the outer peripheral portion 113 has different diameters along the circumferential direction and the second abutment portions 140, 141, and 142 are located on the outer peripheral portion 113. However, the second abutment portions 140, 141, and 142 may be located on the outer peripheral portion 113. Further, according to the above-described configuration, the two second abutment portions 141 and 142 are located in the first recessed portion 114, and therefore the bevel angle can be switched between the three regulation bevel angles without leading to an increase in the size of the regulation member 110.

Further, according to the bevel angle switching mechanism 100, the second abutment portions 141 and 142 are located in the bottom portion 116 of the first recessed portion 114 that is recessed beyond the rotational axis AX4. According to this configuration, a large difference can be secured between the regulation bevel angle corresponding to the second abutment portion 140 and the regulation bevel angles corresponding to the second abutment portions 141 and 142 without leading to an increase in the size of the regulation member 110.

Further, according to the bevel angle switching mechanism 100, the regulation member main body 111 has a C-like shape in cross section taken along the direction orthogonal to the rotational axis AX4. According to this configuration, the function of the regulation member 110 can be realized with a simple shape.

Further, according to the bevel angle switching mechanism 100, the second abutment portion 141 is located on the portion of the adjustment member 112 that partially protrudes into the first recessed portion 114, and the protrusion amount of the adjustment member 112 is adjustable as described above. Therefore, the distance of the second abutment portion 141 from the rotational axis AX4 and thus the regulation bevel angle corresponding to the second abutment portion 141 can be finely adjusted by adjusting the protrusion amount of the adjustment member 112. According to this configuration, the regulation bevel angle can be accurately set to a desired angle with a simple configuration and operation. In addition, in the present embodiment, the regulation bevel angle corresponding to the second abutment portion 141 is 45 degrees, which is especially highly frequently used. In other words, the bevel angle of 45 degrees, which is especially highly frequently used, can be finely adjusted. Therefore, the user's convenience is improved.

Further, according to the bevel angle switching mechanism 100, the operation knob 130 for rotating the regulation member 110 is located on the front side of the front angular plate 60. Therefore, the bevel angle switching mechanism 100 can be disposed using a dead space in front of the front angular plate 60, and therefore an increase in the size of the apparatus can be further reduced.

Further, as illustrated in FIG. 8, the bevel angle switching mechanism 100 is located between the tilt guide 66 and the tilt axis AX3 as viewed in the front-rear direction. Therefore, the bevel angle switching mechanism 100 can be disposed using a dead space between the tilt guide 66 and the tilt axis AX3 behind the front angular plate 60, and therefore an increase in the size of the apparatus can be further reduced.

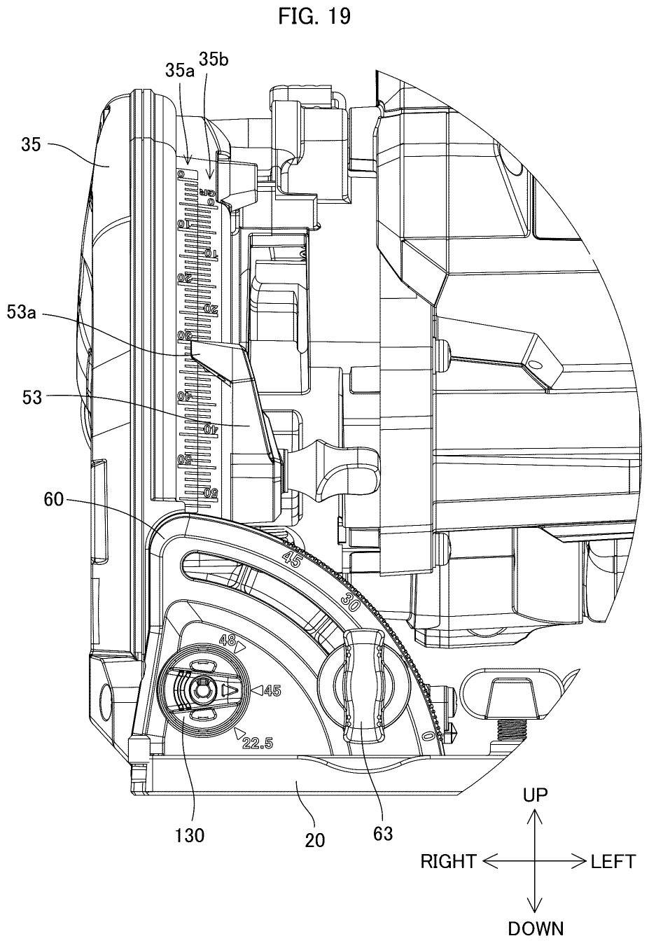

In the following description, a second embodiment will be described, focusing only on differences from the above-described circular saw 10. As illustrated in FIG. 19, the cover 35 includes a first scale 35a and a second scale 35b, which indicate the cutting depth. The scales 35a and 35b are configured to display the cutting depth according to the position of the stopper 53 by an indicator 53a of the stopper 53. The indicator 53a is shared by the scales 35a and 35b. The first scale 35a indicates a cutting depth when no long ruler is in use (i.e., when the circular saw 10 is placed with the lower surface of the base 20 in abutment with the cutting target material). The second scale 35b indicates a cutting depth when the long ruler is in use (i.e., when the circular saw 10 is placed on the long ruler). According to this configuration, the cutting depth can be easily recognized both when the long ruler is not in use and when the long ruler is in use, and therefore the user's convenience is improved.

Having described several embodiments, the above-described embodiments are intended to only facilitate the understanding of the present teachings, and are not intended to limit the present invention thereto. The present invention can be modified or improved without departing from the spirit thereof, and the present invention includes equivalents thereof. Further, each of the forms/elements described in the claims and the specification can be combined in any manner or omitted in any manner within a range that allows it to remain capable of achieving at least a part of the above-described objects or bringing about at least a part of the above-described advantageous effects.

For example, the bevel angle switching mechanism 100 may be attached to the rear angular plate 80 instead of the front angular plate 60. Further, the number of regulation bevel angles switchable by the bevel angle switching mechanism 100 (i.e., the number of second abutment portions) can be any number equal to or larger than two. Further, the shape of the regulation member 110 can be changed to any shape as long as the plurality of abutment portions are located at positions different from one another in the circumferential direction with respect to the rotational axis AX4 and also located at positions different from one another in the radial direction with respect to the rotational axis AX4. Further, the position (the distance from the rotational axis AX4) of at least one of the second abutment portions 140 and 142 may be finely adjustable instead of or in addition to the second abutment portion 141.

Further, the above-described various configurations (for example, the bevel angle switching mechanism 100 and the first abutment portion 101, or the scales 35a and 35b) may be applied to not only the plunge-type circular saw but also a non-plunge type circular saw. In this case, a main body portion of the circular saw may be tiltable about an imaginary axis similarly to the above-described embodiments or may be tiltable about a support shaft. Further, the above-described various embodiments can be applied to not only the circular saw but also various portable cutting apparatuses configured to be able to change a bevel angle of a main body portion with respect to a base, such as a cutter using a diamond wheel as a blade.

### DESCRIPTION OF THE REFERENCE NUMERALS

10 portable circular saw
11 motor housing
20 base
21 recessed portion
30 main body portion
30a swing portion
31 motor housing
32 gear housing
33 battery mount portion
34 handle
35 cover
35a first scale
35b second scale
36 electric motor
37 battery
38 trigger
39 through-hole
40 blade
41 angular
42 base portion
43 shaft support portion
44 front angular guide
44a threaded boss
44b, 44c, 44d boss
45 rear angular guide
46 support shaft
47 biasing spring
48 lock pin
49 recessed portion
50 lock release lever
51 protrusion portion
52 through-hole
53 stopper
53a indicator
60 front angular plate
60a, 60b boss
60c through-hole
60d second recessed portion
60e, 60f opening portion
61 through-hole
62 thumbscrew
63 operation knob
64 shaft
66 tilt guide
67 through-hole
68, 69 positioning pin
70 guide pin
71 link arm
71a, 71b through-hole
72 support shaft
73 engagement pin
80 rear angular plate
82 thumbscrew
100 bevel angle switching mechanism
101 first abutment portion
110 regulation member
111 regulation member main body
112 adjustment member
113 outer peripheral portion
114 first recessed portion
115 opening portion
116 bottom portion
117 threaded hole
120 pin
121 first end
122 second end
130 operation knob
131 through-hole
132 protrusion portion
134 indicator
135 stop ring
140, 141, 142 second abutment portion
AX1 rotational axis
AX2 swing axis
AX3 tilt axis
AX4 rotational axis

1. A portable cutting apparatus comprising:
a base;
a main body portion including a rotatable blade and a first abutment portion, the main body portion being configured to be tilted with respect to the base about a tilt axis extending in a front-rear direction, a front side being defined to be one side to which the portable cutting apparatus is advanced when a cutting target material is cut by the blade, and a rear side being defined to be an opposite side from the front side;
an angular plate fixed to the base and supporting the main body portion tiltably about the tilt axis; and
a bevel angle switching mechanism including a regulation member configured to selectively regulate a bevel angle of the blade with respect to the base to one of a plurality of predetermined regulation bevel angles, the bevel angle switching mechanism being configured to switch the bevel angle among the plurality of regulation bevel angles,
wherein the regulation member is supported by the angular plate in such a manner that the regulation member faces the main body portion in the front-rear direction and rotates about a rotational axis parallel with the tilt axis,
the regulation member includes a plurality of second abutment portions respectively corresponding to the plurality of regulation bevel angles,
the plurality of second abutment portions are located at positions different from one another in a circumferential direction with respect to the rotational axis and also located at positions different from one another in a radial direction with respect to the rotational axis, and
the plurality of second abutment portions are configured in such a manner that, when the main body portion is tilted with respect to the base, one second abutment portion determined according to a rotational angle position of the regulation member, among the plurality of second abutment portions, is brought into abutment with the first abutment portion in a direction intersecting with the front-rear direction so that the bevel angle is regulated to the corresponding regulation bevel angle.

2. The portable cutting apparatus according to claim 1, wherein the regulation member has such a columnar shape that a longitudinal direction thereof extends in the front-rear direction.

3. The portable cutting apparatus according to claim 2, wherein the regulation member includes a first recessed portion recessed in the radial direction with respect to the rotational axis, and
the plurality of second abutment portions includes a first rotational angle abutment portion located on an outer peripheral portion of the regulation member and a second rotational angle abutment portion located in the first recessed portion.

4. The portable cutting apparatus according to claim 3, wherein the first recessed portion includes a bottom portion that is a portion recessed beyond the rotational axis in the radial direction, and
the second rotational angle abutment portion is located in the bottom portion.

5. The portable cutting apparatus according to claim 4, wherein the regulation member has a C-like shape in cross section taken along a direction orthogonal to the rotational axis.

6. The portable cutting apparatus according to claim 3, wherein the plurality of second abutment portions includes a third rotational angle abutment portion located in the first recessed portion.

7. The portable cutting apparatus according to claim 1, wherein at least one of the plurality of second abutment portions is configured in such a manner that a distance thereof from the rotational axis is finely adjustable.

8. The portable cutting apparatus according to claim 3, wherein the regulation member includes:
a regulation member main body including the first recessed portion; and
an adjustment member partially protruding into the first recessed portion and attached to the regulation member main body in such a manner that a protrusion amount thereof is adjustable, and
the second rotational angle abutment portion is located on a portion of the adjustment member that partially protrudes into the first recessed portion and a distance thereof from the rotational axis is finely adjustable by adjusting the protrusion amount.

9. The portable cutting apparatus according to claim 8, wherein the second rotational angle abutment portion corresponds to a regulation bevel angle of 45 degrees.

10. The portable cutting apparatus according to claim 8, wherein the adjustment member includes an adjustment screw extending in a direction intersecting with the front-rear direction and threadedly engageable with the regulation member main body.

11. The portable cutting apparatus according to claim 1, wherein the angular plate includes a second recessed portion on one side thereof in the front-rear direction where the main body portion is located, the second recessed portion having a circular arc-shaped inner side surface, the second recessed portion being opened toward the main body portion, and
the regulation member has an outer shape that conforms with the inner side surface of the second recessed portion, and is rotatably contained in the second recessed portion.

12. The portable cutting apparatus according to claim 1, wherein the bevel angle switching mechanism further includes a pin extending in the front-rear direction through inside the angular plate, and an operation knob located on an opposite side of the angular plate from the main body portion in the front-rear direction,
the pin includes a first end located on a closer side to the main body portion and a second end located on a farther side from the main body portion in the front-rear direction,
the operation knob is coupled with the second end, and
the regulation member is coupled with the first end and is configured to be rotatable integrally with the operation knob via the pin.

13. The portable cutting apparatus according to claim 1, further comprising a tilt guide fixed to the angular plate on a closer side to the main body portion with respect to the angular plate in the front-rear direction, the tilt guide having a through-hole extending in a circular-arc form along a direction in which the main body portion is tilted,
wherein the main body portion includes a guide pin extending in the through-hole and slidable on an inner surface defining the through-hole,
the tilt axis is an imaginary axis located opposite of the base from the angular plate, and
the bevel angle switching mechanism is located between the tilt guide and the tilt axis as viewed in the front-rear direction.

14. The portable cutting apparatus according to claim 2, wherein the regulation member includes a first recessed portion recessed in the radial direction with respect to the rotational axis,
the plurality of second abutment portions includes a first rotational angle abutment portion located on an outer peripheral portion of the regulation member and a second rotational angle abutment portion located in the first recessed portion,
the angular plate includes a second recessed portion on one side thereof in the front-rear direction where the main body portion is located, the second recessed portion having a circular arc-shaped inner side surface, the second recessed portion being opened toward the main body portion, and
the regulation member has an outer shape that conforms with the inner side surface of the second recessed portion, and is rotatably contained in the second recessed portion.

15. The portable cutting apparatus according to claim 2, wherein the regulation member includes a first recessed portion recessed in the radial direction with respect to the rotational axis,
the plurality of second abutment portions includes a first rotational angle abutment portion located on an outer peripheral portion of the regulation member and a second rotational angle abutment portion located in the first recessed portion,
the bevel angle switching mechanism further includes a pin extending in the front-rear direction through inside the angular plate, and an operation knob located on an opposite side of the angular plate from the main body portion in the front-rear direction,
the pin includes a first end located on a closer side to the main body portion and a second end located on a farther side from the main body portion in the front-rear direction,
the operation knob is coupled with the second end, and
the regulation member is coupled with the first end and is configured to be rotatable integrally with the operation knob via the pin.

16. The portable cutting apparatus according to claim 1, wherein the angular plate includes a second recessed portion on one side thereof in the front-rear direction where the main body portion is located, the second recessed portion having a circular arc-shaped inner side surface, the second recessed portion being opened toward the main body portion,
the regulation member has an outer shape that conforms with the inner side surface of the second recessed portion, and is rotatably contained in the second recessed portion,
the bevel angle switching mechanism further includes a pin extending in the front-rear direction through inside the angular plate, and an operation knob located on an opposite side of the angular plate from the main body portion in the front-rear direction,
the pin includes a first end located on a closer side to the main body portion and a second end located on a farther side from the main body portion in the front-rear direction,
the operation knob is coupled with the second end, and
the regulation member is coupled with the first end and is configured to be rotatable integrally with the operation knob via the pin.
